(19) United States
(12) Patent Application Publication
(10) Pub. No.: US 2013/0173144 A1
(43) Pub. Date: Jul. 4, 2013

(54) Starter Motor Assembly

(71) Applicant: Michael D. Bradfield, Anderson, IN (US)

(72) Inventor: Michael D. Bradfield, Anderson, IN (US)

(73) Assignee: REMY TECHNOLOGIES, LLC, Pendleton, IN (US)

(21) Appl. No.: 13/341,725

(22) Filed: Dec. 30, 2011

(51) Int. Cl. F02N 11/08

(52) U.S. Cl. 701/113

(57) ABSTRACT

A control system for the starter assembly of an engine includes a first field effect transistor (FET) electrically connected between an electrical power supply and the starter motor and a second FET electrically connected between the power supply and the solenoid. A control unit is electrically connected to the gate of each FET and is configured to selectively apply a voltage to each gate, wherein the FET provides a current to the respective starter motor and solenoid as a function of the applied voltage. The control unit can selectively apply the gate voltages for cold start, soft start, and start-stop operation of the engine, and in response to sensor signals received by the control unit, such as ring gear rotational speed.

### FIELD

This application relates to the field of vehicle starters, and more particularly, to solenoids and motor control for starter motor assemblies.

### BACKGROUND

Starter motor assemblies that assist in starting engines, such as engines in vehicles, are well known. A conventional starter motor assembly is shown in FIG. 1. The starter motor assembly 200 of FIG. 1 includes a solenoid 210, an electric motor 202, and a drive mechanism 204. The solenoid 210 includes a coil arrangement 211 that is energized by a battery upon the closing of an ignition switch. When the coil arrangement 211 is energized, a plunger 216 moves in a linear direction, causing a shift mechanism, such as shift lever 205, to pivot, and forcing a pinion gear 206 into engagement with a ring gear of a vehicle engine (not shown). When the plunger 216 reaches a plunger stop, electrical contacts are closed connecting the electric motor 202 to the battery B (FIG. 2). The energized electric motor 202 then rotates and provides an output torque to the drive mechanism 204. The drive mechanism 204 transmits the torque of the electric motor through various drive components to the pinion gear 206 which is engaged with the ring gear of the vehicle engine. Accordingly, rotation of the electric motor 202 and pinion gear 206 results in cranking of the engine until the engine starts.

Many starter motor assemblies, such as the starter motor assembly 200 of FIG. 1 may be configured with a “soft-start” starter motor engagement system. The intent of a soft start starter motor engagement system is to provide limited power to the starter motor before the pinion gear engages the engine ring gear. Once the pinion gear meshes with the engine ring gear full electrical power is applied to the starter motor. If the pinion gear abuts into the ring gear during this “soft start”, the motor provides a small torque to turn the pinion gear and allow it to properly mesh into the ring gear before high current is applied. The configuration of the solenoid, shift yoke, electrical contacts, and motor drive are such that high current is not applied to the motor before the gears are properly meshed. Accordingly, milling of the pinion gear and the ring gear is prevented in a starter motor with a soft-start engagement system.

Starters with a soft start engagement system typically include a coil arrangement with two distinct coils—a pull-in coil 212 and a hold in coil 214. During operation of the starter, the closing of the ignition switch I (typically upon the operator turning a key) energizes both the pull-in coil 212 and the hold-in coil 214, as reflected in the conventional starter circuit diagram of FIG. 2. The electric motor 202 is in series with the pull-in coil so that current flowing through the pull-in coil 212 at this time also reaches the motor, applying some limited power to the electric motor, and resulting in some low torque turning of the pinion gear. Energization of the pull-in coil 212 and hold-in coil 214 moves the solenoid shaft or plunger in an axial direction. The axial movement of the solenoid plunger moves the shift lever 205 and biases the pinion gear 206 toward engagement with the engine ring gear. (FIG. 1) As the pinion moves toward engagement with the ring gear, it freely rotates. However, once the pinion abuts the ring gear, the rotational speed of the pinion gear is limited by frictional drag, which prevents further acceleration of the pinion gear. Thus, the pinion rotates into full mesh with the ring gear at a relatively slow rotational speed (relative to the normal cranking speed), which allows the pinion and ring gears to more easily mesh.

Prior to the solenoid plunger reaching the plunger stop, a set of electrical contacts 220 is closed, thereby delivering full power to the electrical motor. Closing of the electrical contacts effectively short circuits the pull-in coil 212, preventing thermal related failures of the pull-in coil. However, with the pull-in coil shorted, the hold-in coil 214 provides sufficient electromagnetic force to hold the plunger in place and maintain the electrical contacts in a closed position, thus allowing the delivery of full power to continue to the electric motor 202. The fully powered electric motor 202 drives the pinion gear 206, resulting in rotation of the engine ring gear, and thereby cranking the vehicle engine.

After the engine fires (i.e., vehicle start), the operator of the vehicle opens the ignition switch I. The electrical circuit of the starter motor assembly is configured such that opening of the ignition switch causes current to flow through the hold-in coil and the pull-in coil in opposite directions as long as the contacts 220 are closed. The pull-in coil 212 and the hold-in coil 214 are configured such that the electromagnetic forces of the two coils 212, 214 cancel each other upon opening of the ignition switch, and a return spring 217 (and in some cases an over-travel spring 218) forces the plunger 216 back to its original un-energized position. As a result, the electrical contacts 220 that connected the electric motor 202 to the source of electrical power are opened, and the electric motor is de-energized.

Wear due to gear milling can be a problem for starter gears. In most cases the engine is stopped so the ring gear is not rotating, but the pinion gear is rotating as it is advanced into engagement. In other cases the engine ring gear may be rotating. In these cases the pinion gear is at least initially rotating at a different speed, but even when rotating at the same speed as the ring gear milling still occurs until the gears are meshed. It is desirable to minimize gear milling that occurs in either case. It is also desirable for the pinion gear to be fully engaged to the ring gear before full torque is applied to the pinion gear to start the engine.

In certain applications, the “soft start” starter assemblies are utilized in vehicles in which the engine is automatically stopped such as a traffic light, and then quickly restarted when the traffic light turns and the driver performs an operation to move the vehicle, such as releasing the brake pedal. In these cases, it is important that the engine re-start quickly and reliably. The speed of the engine restart can be reduced by ensuring that the starter pinion gear is meshed with the engine ring gear even before an engine start command is required. Since it is highly undesirable to maintain the starter pinion gear constantly meshed with the engine ring gear, it is necessary to provide a starter assembly that is capable of efficiently engaging the pinion gear to the ring gear, while still minimizing gear milling.

### SUMMARY

In one aspect, a control system for the starter assembly of an engine is provided that comprises a first field effect transistor (FET) electrically connected between an electrical power supply and the starter motor, and a second FET electrically connected between the power supply and the solenoid. A control unit is electrically connected to the gate of each FET and is configured to control a voltage applied to each gate so that the FET provides a variable voltage to the respective starter motor and solenoid. The control unit can selectively apply the gate voltages for cold start, soft start, and start-stop operation of the engine, and in response to sensor signals received by the control unit, such as ring gear rotational speed.

In a further aspect, a single FET is electrically connected between the pull-in and hold-in coils of a solenoid of a starter assembly. A control unit is electrically connected to the gate of the FET and is operable to control the FET to control the electrical power supplied to the coils. In one embodiment the control unit can control the FET by pulse width modulation. The starter motor is connected in series with the pull-in coil so that electrical power is supplied to the motor through the FET and the pull-in coil. In one feature, the starter motor is also connected to the power supply through electrical contacts, while the solenoid plunger is coupled to a contact plate that is movable to close the electrical contacts, thereby shorting the pull-in coil so that the electrical power is supplied to the starter motor directly from the electrical power supply and not through the FET.

### DESCRIPTION OF THE FIGURES

FIG. 1 is partial cross-sectional view of a conventional engine starter assembly.

FIG. 2 is a circuit diagram of a conventional electrical circuit for the engine starter assembly shown in FIG. 1.

FIG. 3 is a circuit diagram of an electrical circuit according to the present disclosure for the starter assembly of FIG. 1.

FIG. 4 is a graph of spring force and solenoid current for the starter assembly shown in FIG. 1.

FIG. 5 is a graph of a voltage applied to the solenoid in the circuit diagram of FIG. 3.

FIG. 6 is a circuit diagram of an electrical circuit according to a further embodiment of the present disclosure for the starter assembly of FIG. 1.

FIG. 7 is a graph of a voltage applied to the starter motor and solenoid in the circuit of FIG. 6 for a normal cold start condition.

FIG. 8 is a graph of the voltage applied to the starter motor and solenoid in the circuit of FIG. 6 in a start-stop condition.

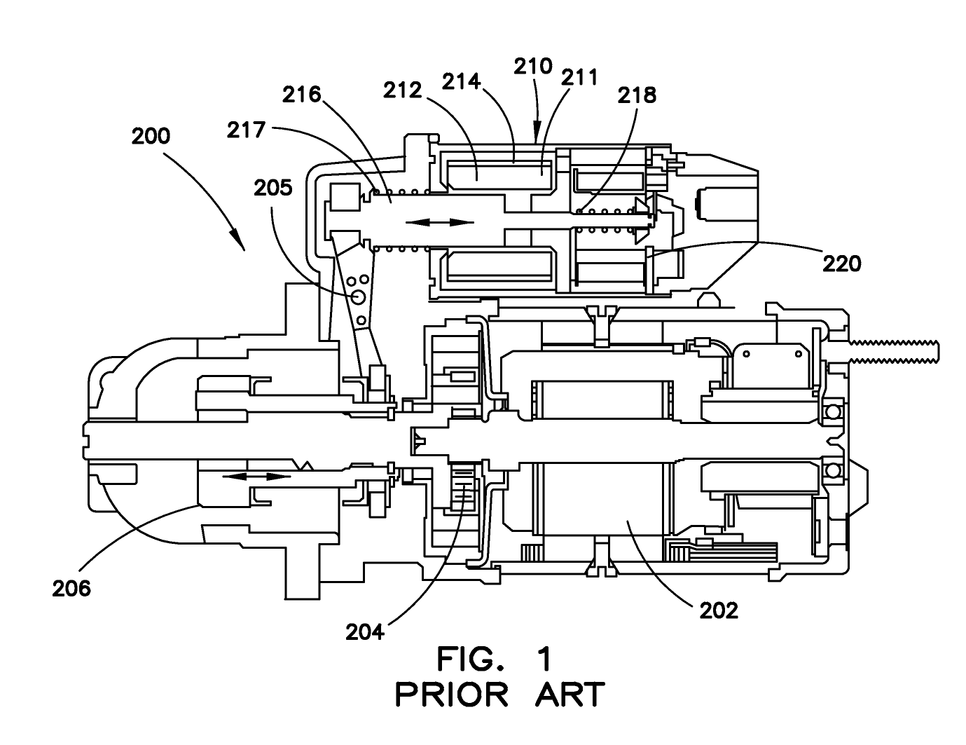

### DETAILED DESCRIPTION

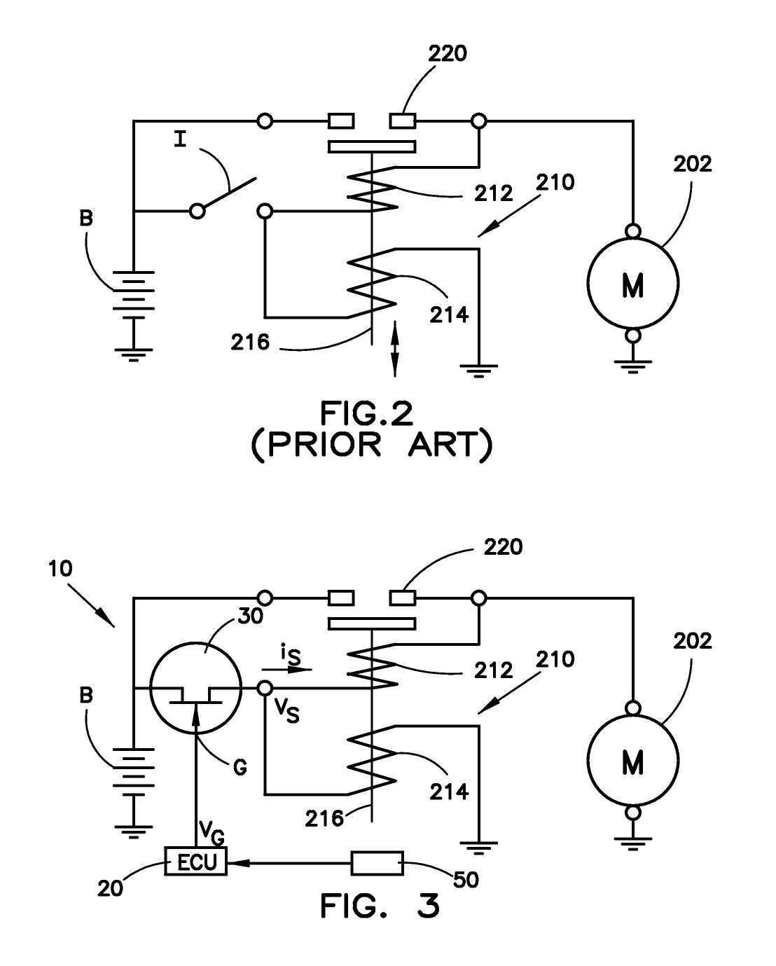

In one aspect of the present disclosure, the starter circuit for energizing the coils 212, 214 of the starter solenoid 210 is modified from the conventional circuit depicted in FIG. 2. In particular, the modified starter circuit 10 illustrated in FIG. 3 integrates with an engine control unit (ECU) 20 and replaces the ignition switch I (which may, for instance, constitute an ignition solenoid that is actuated by a user-operated key switch) with a field effect transistor (FET) 30. The ECU 20 controls the voltage V_{G} provided to the gate G of the FET 30 so that the FET 30 can provide a variable effective voltage to the solenoid 210. In one embodiment, the FET provides a variable voltage through pulse-width modulation in which the ECU rapidly turns the voltage V_{G} on and off, with the dwell between on and off states establishing the FET voltage. The inductance of the circuit in FIG. 3 smoothes the switched voltage to an effective voltage provided to the solenoid coils and motor. The engine control unit can be of conventional design, incorporating a microprocessor capable of executing stored commands or stored programs to sense engine conditions and control the operation of the engine and other components.

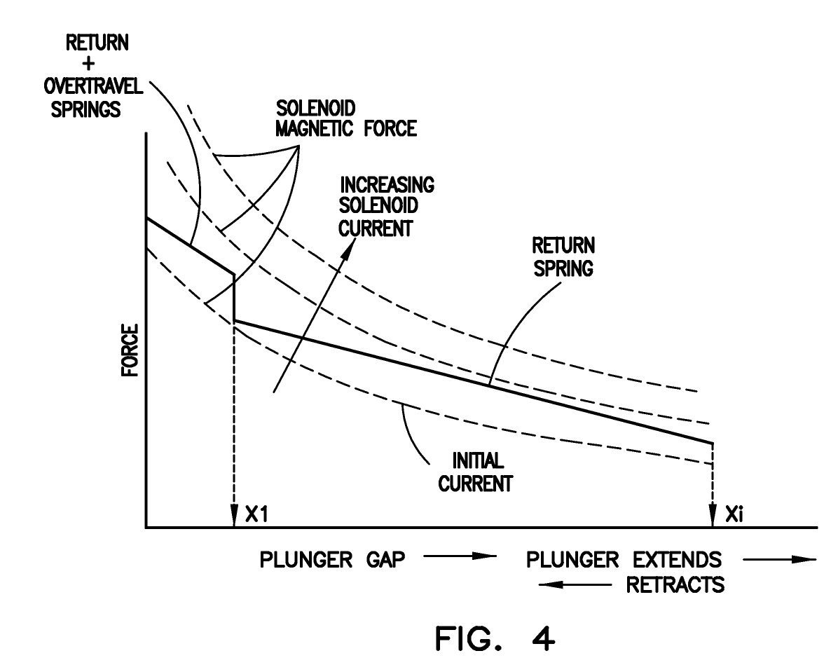

It is known that the magnetic force generated by the two coils 212, 214 is a function of the current provided to the coils. The axial movement of the plunger due to the coil magnetic forces is resisted by the spring force of the return spring 217 until the contacts 220 are closed, and then by the combination of the return spring and over-travel spring 218 thereafter. The coil magnetic force and spring forces increase as the plunger is retracted further into the solenoid, as shown in FIG. 4. As reflected in FIG. 4, the resistive spring force increases incrementally at plunger position X1 by the amount of pre-load of the over-travel spring 218. It is at this point that full battery voltage is supplied to the motor to drive the pinion gear at its operational speed. At this point X1 the pinion gear should be substantially meshed with the ring gear. Thus, prior to the plunger reaching position X1 the pinion gear should be meshed with the ring gear to avoid unnecessary gear milling.

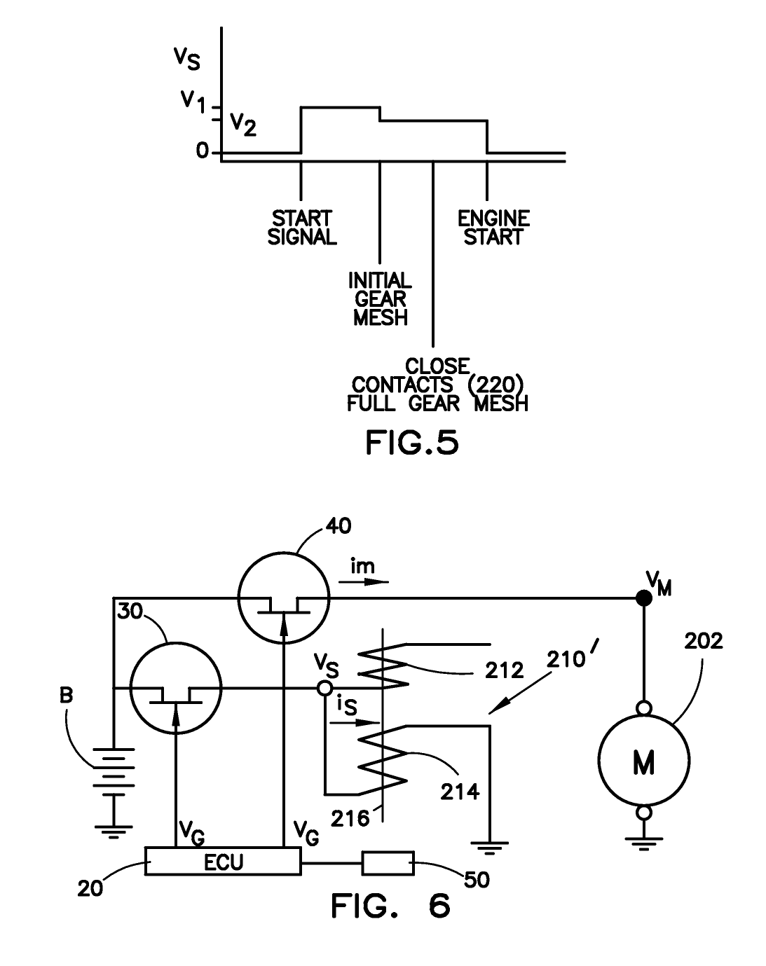

In the conventional non stop-start circuit of FIG. 2, once the ignition switch I is closed the solenoid 210 uniformly drives the plunger 216 to shift the pinion gear and close the contacts 220. In the conventional non stop-start circuit, full battery voltage can be applied to the starter motor driving the pinion before the pinion gear is fully meshed with the ring gear. Under certain conditions, it is desirable to delay fully energizing the pinion motor 202 until the pinion gear is fully meshed with the engine ring gear. This concern is addressed by the circuit of FIG. 3 in which the ECU controls FET 30 to control the voltage V_{S} to more accurately determine when the contacts 220 are closed to fully energize the starter motor 202. Thus, as shown in the graph of FIG. 5, the voltage V_{S} is initially zero, corresponding to a de-energized state of the solenoid 210. When a start signal is received by the ECU 20, the ECU modulates the voltage V_{G} applied to the gate of the FET 30 corresponding to a solenoid voltage V_{S} of V₁. At this voltage the current through the solenoid coils 212, 214 drives the plunger 216 to shift the pinion gear, overcoming the spring force of the return spring 216. Once the pinion gear is initially meshed with the ring gear, it is desirable to slow down the advance of the plunger toward the contacts 220 to allow the gears to be fully meshed before full motor power is applied. Thus, the ECU is configured to modulate the voltage V_{G} to the FET 30 to reduce the voltage V_{S} to V₂, as reflected in FIG. 5. The ECU may be provided with a signal from a sensor 50 that indicates when the pinion and ring gears mesh. The reduced voltage V_{S}, and thus reduced current i_{S}, to the solenoid cause the plunger to advance more slowly to the contacts 220 while simultaneously advancing the pinion gear to fully mesh with the ring gear. At some point in the travel of the plunger the contacts 220 are closed and the motor 202 is directly connected to the power supply B to drive the starter motor at its full operational speed.

In an alternative approach, the sensor 50 may be a ring gear speed sensor. In certain circumstances, it is desirable to engage the pinion gear to the ring gear while the ring gear is still rotating, albeit decelerating. If the ring gear is rotating too fast the pinion gear cannot mesh and it is unnecessary, and even damaging, to rotate the pinion gear at full speed. The ECU 20 can implement the same protocol shown in the graph of FIG. 5 except that the start signal is based on the ring gear speed. The ECU can be configured to determine a differential speed between the pinion gear (if it is rotating) and the ring gear, and to compare that differential speed to a stored threshold value. The “start signal” of FIG. 5 thus corresponds to a determination that the differential speed is below the threshold value. Alternatively the ECU can compare the ring gear speed, as determined by the sensor 50, and compare that to a speed threshold value, with the “start signal” again corresponding to the ring gear speed falling below the threshold.

As shown in the circuit diagram of FIG. 3, the FET 30 controls the current provided to both the pull-in coil 212 and the hold-in coil 214. In addition, until the pull-in coil is short circuited by closure of the contacts 220, the pull-in coil variably feeds current to the motor 202 by virtue of their series connection. Once the contacts 220 are closed, the pull-in coil is short-circuited and the motor 202 is fed directly by the power supply or battery B, rather than through the FET 30. The hold-in coil 214, however, remains energized to hold the solenoid plunger in the contact closure position.

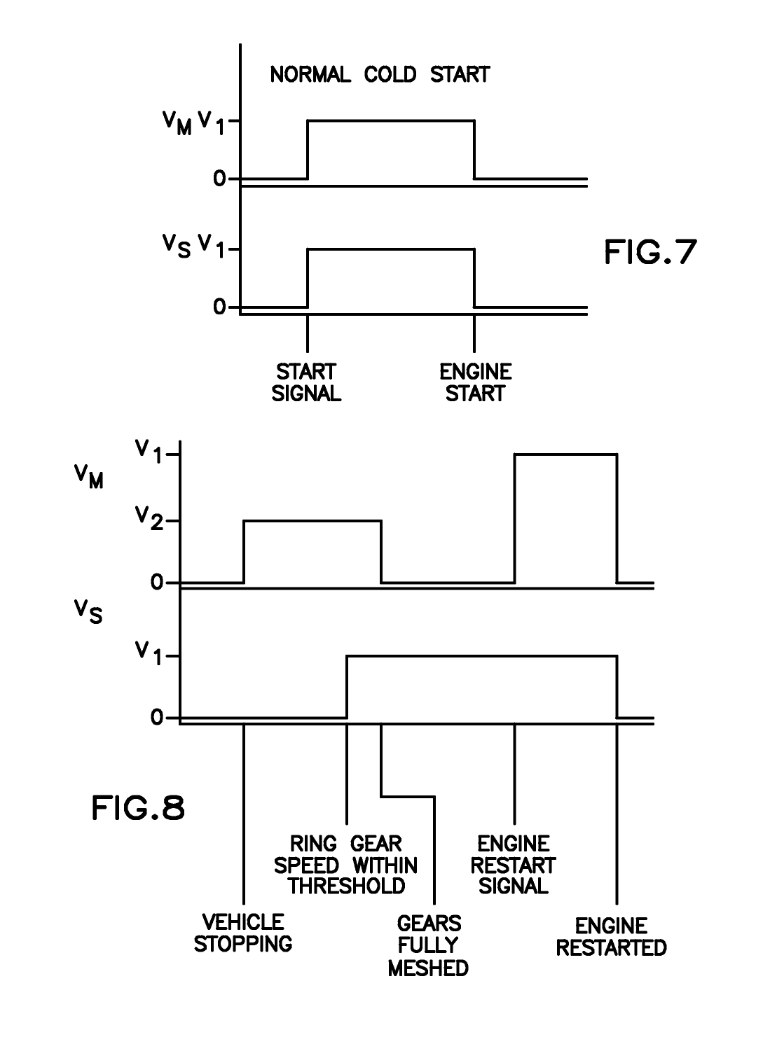

In another embodiment, the contacts 220 are replaced by an FET 40 connected between the starter motor 202 and the power supply B, and controlled by the ECU 20, as shown in the circuit diagram of FIG. 6. In this configuration, the solenoid plunger operates only to shift the pinion gear into engagement with the ring gear. The voltage V_{S} provided to the solenoid 210′ is also controlled by the ECU 20 through the FET 30. It can be appreciated that the two FETs 30, 40 replace the ignition switch I of the starter system shown in FIG. 2 and provide a control capability absent in the prior system. The ECU can control the two FETs according to a variety of protocols. In a normal cold start condition, the ECU 30 can modulate the voltage signals V_{G} to the gates of the corresponding FETs 30, 40 to provide full battery voltage V₁ to the solenoid and starter motor, as reflected in FIG. 7.

The ECU 20 can receive signals from sensors 50, which can include a ring gear speed sensor. The ECU can poll the sensor 50 to determine whether the engine is operating—i.e., whether the ring gear is rotating. If it is not, then the ECU can direct implementation of the normal cold start protocol of FIG. 7. If the ring gear is rotating the ECU can implement the protocol depicted in FIG. 8. According to this protocol, the ECU initially controls the FET 40 to provide a voltage V_{M} at a lower initial value V₂ to the starter motor 202 to limit the motor torque. Since the pinion gear is not yet meshed with the ring gear, a higher driving torque would cause the pinion gear to mill against the ring gear, hence the lower initial torque. The lower torque mode continues while the ECU 20 evaluates the ring gear speed signal from the sensor 50. As explained above, the ECU can determine whether the difference between ring gear and pinion gear rotational speeds falls below a predetermined threshold (or whether the ring gear speed itself falls below a threshold), at which point the ECU 20 applies a voltage to the gate of the FET 30 for the solenoid. The energized solenoid advances the plunger and thus the pinion gear until it meshes with the ring gear. Once the gears are meshed the ECU can deenergize the starter motor until an engine restart signal is received by the ECU. The solenoid remains energized so that the starter gear remains meshed with the ring gear. Once an engine restart is commanded the ECU can apply a new voltage to the motor ECU 40 so supply the greater battery voltage V₁ to the motor to drive the motor at its operational speed for starting the engine. Once the engine is restarted the ECU can drop the voltage V_{G} to the FETs 30, 40 to deenergize the solenoid and starter motor.

It can be appreciated that the use of ECU commanded FETs 30, 40 to supply controllable voltage to the solenoid 210 and starter motor 202 provides a great deal of flexibility to the engine start/restart protocols, particularly with the addition of condition sensors 50, such as a ring gear speed sensor. The ECU can evaluate various engine conditions to determine which protocol is appropriate to implement. Other sensors may be added that are specific to the starter system, such as position or proximity sensors to determine the location of the solenoid plunger, or force sensors to measure solenoid and/or spring forces. The use of FETs allows calibration of the voltage and current supplied to the solenoid and starter motor to minimize response time while reducing gear milling.

What is claimed is:

1. A control system for a starter assembly of an engine, the assembly having a pinion gear for engaging an engine ring gear, a starter motor for rotating the pinion gear in response to a current applied to the motor, a mechanism for shifting the pinion gear from a neutral position out of engagement with the ring gear and an engaged position in engagement with the ring gear the mechanism including a solenoid having a plunger operable to shift the pinion gear between the neutral and engaged positions in response to a current applied to the solenoid, said control system comprising:
a first field effect transistor (FET) electrically connected between an electrical power supply and the solenoid;
a second FET electrically connected between the power supply and the starter motor; and
a control unit electrically connected to the gate of each of said first FET and second FET, said control unit configured to control a voltage applied to each gate, wherein each FET provides a voltage to the respective solenoid and starter motor as a function of the voltage applied to the associated gate.

2. The control system of claim 1, wherein said control unit is configured to selectively control the voltage applied to the gate of said second FET so that said second FET supplies a first voltage to the starter motor or so that said second FET supplies a second voltage to the starter motor that is greater than said first voltage.

3. The control system of claim 1, wherein said control unit is configured to control the voltage applied to the gate of said first and second FET by pulse width modulation.

4. The control system of claim 1, wherein said control unit receives a signal indicative of the ring gear rotational speed and is further configured to control the voltage applied to the gate of at least one of said first FET and second FET as a function of the ring gear rotational speed.

6. The control system of claim 5, wherein said control unit is configured to apply a voltage to the gate of said first FET only when the ring gear is rotating at a rotational speed that is within a predetermined threshold.

7. The control system of claim 5, wherein said control unit is configured to control the voltage applied to the gate of said second FET so that said second FET provides a first voltage to said solenoid when the ring gear rotational speed exceeds said predetermined threshold and to control the voltage applied to the gate of said second FET so that said second FET provides a second voltage to said solenoid greater than said first voltage when the ring gear rotational speed is within a predetermined threshold.

8. A control system for a starter assembly of an engine, the assembly having a pinion gear for engaging an engine ring gear, a starter motor for rotating the pinion gear in response to a current applied to the motor, a mechanism for shifting the pinion gear from a neutral position out of engagement with the ring gear and an engaged position in engagement with the ring gear, the mechanism including a solenoid having a plunger operable to shift the pinion gear between the neutral and engaged positions in response to a current applied to the solenoid, said control system including:
a field effect transistor (FET) electrically connected between an electrical power supply and the solenoid; and
a control unit electrically connected to the gate of said FET, said control unit configured to control a voltage applied to the gate, wherein said FET provides a voltage to the solenoid as a function of the voltage applied to the gate.

9. The control system of claim 8, in which the solenoid includes a pull-in coil connected in series with the starter motor and a hold-in coil connected in parallel with the pull-in coil, wherein the FET is electrically connected in series between each coil and the electrical power supply so that electric power is supplied to the starter motor through said FET and the pull-in coil.

10. The control system of claim 9, in which the starter assembly includes open electrical contacts electrically connected between the starter motor and an electrical power supply, wherein the plunger is coupled to a contact plate arranged to contact said electrical contacts to complete an electrical circuit when the plunger is in the engaged position to thereby short circuit the pull-in coil so that electric power is not supplied to the starter motor through said FET and pull-in coil.

11. The control system of claim 8, wherein said control unit configured to selectively control the voltage applied to the gate of said FET so that said FET supplies a first voltage to the solenoid or so that said FET supplies a second voltage to the solenoid that is less than said first voltage.

12. The control system of claim 8, wherein said solenoid is operable at said first voltage to shift the pinion gear to a position between the neutral and engaged positions, and is operable at said second voltage to shift the pinion gear to the engaged position.

13. The control system of claim 8, wherein said control unit is configured to control the voltage applied to the gate of said FET by pulse width modulation

14. The control system of claim 8, wherein said control unit receives a signal indicative of the ring gear rotational speed and is further configured to apply the voltage to the gate of said FET as a function of the ring gear rotational speed.

15. The control system of claim 14, wherein said control unit is configured to control the FET to apply said second voltage only when the ring gear is rotating at a rotational speed that is within a predetermined threshold.
